(19) United States
(12) Patent Application Publication
(10) Pub. No.: US 2014/0368781 A1
(43) Pub. Date: Dec. 18, 2014

(54) LIQUID CRYSTAL DISPLAY AND METHOD FOR MANUFACTURING THE SAME

(71) Applicant: SAMSUNG DISPLAY CO., LTD., Yongin-city (KR)

(72) Inventors: Dae Ho Song, Yongin-city (KR); Jae Cheol Park, Yongin-city (KR); Min-Woo Lee, Yongin-city (KR); Gyeong Eun Eoh, Yongin-city (KR); Min Jeong Oh, Yongin-city (KR)

(73) Assignee: SAMSUNG DISPLAY CO., LTD., Yongin-city (KR)

(21) Appl. No.: 14/066,187

(22) Filed: Oct. 29, 2013

(30) Foreign Application Priority Data
Jun. 17, 2013 (KR) 10-2013-0069110

(51) Int. Cl. G02F 1/1341

(52) U.S. Cl. CPC G02F 1/1341
USPC 349/139; 349/189

(57) ABSTRACT

In an aspect, a liquid crystal display is provided. The liquid crystal display may include a substrate, a thin film transistor disposed on the substrate, a pixel electrode connected to one terminal of the thin film transistor, a roof layer disposed to face the pixel electrode, and a capping layer disposed on the roof layer, in which a microcavity having a liquid crystal injection hole is formed between the pixel electrode and the roof layer, the microcavity forms a liquid crystal layer including a liquid crystal molecule, and the capping layer covers the liquid crystal injection hole and includes a water-soluble polymer material.

### INCORPORATION BY REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0069110 filed in the Korean Intellectual Property Office on Jun. 17, 2013, the disclosure of which is incorporated herein by reference in its entirety.

### BACKGROUND

1. Field

This disclosure relates to a liquid crystal display and a method of manufacturing the same.

2. Description of the Related Technology

A liquid crystal display is one of the most common types of flat panel displays currently in use, and includes two display panels formed of field generating electrodes such as a pixel electrode and a common electrode, and a liquid crystal layer interposed therebetween.

A liquid crystal display displays an image by applying a voltage to the field generating electrodes to generate an electric field on the liquid crystal layer, and thus to determine alignment of liquid crystal molecules of the liquid crystal layer, and control polarization of incident light.

A NCD (nanocrystal display) liquid crystal display is a device in which a display is obtained by forming a sacrificial layer using an organic material, forming a roof layer on an upper portion, removing the sacrificial layer, and filling liquid crystal in a microcavity formed by removing the sacrificial layer.

Herein, the liquid crystal may be injected through a liquid crystal injection hole of the microcavity, and after the liquid crystal is injected, capping may be performed by a coating material such as parylene in order to clog the liquid crystal injection hole.

However, known coating materials may have problems when covering the liquid crystal injection hole of coming into contact with the liquid crystal, which causes a contamination of the liquid crystal. Moreover, the coating material is applied on an entire surface of the panel and thus is cumbersome in that a tape is attached to an outskirt portion before the coating material is applied and the tape is detached after application in order to expose a pad portion of the outskirt portion of the panel.

The above information disclosed in this BACKGROUND section is only for enhancement of understanding of the background of the disclosure and therefore it may contain information that does not form the prior art that is already known in this country to a person of ordinary skill in the art.

### SUMMARY

Some embodiments provide a liquid crystal display including a capping layer for clogging a liquid crystal injection hole without contaminating the liquid crystal, and a method of manufacturing the same.

Some embodiments provide a liquid crystal display including a capping layer formed of a material that can be subjected to a photoprocess, and a method of manufacturing the same.

Some embodiments provide a liquid crystal display including: a substrate, a thin film transistor disposed on the substrate, a pixel electrode connected to one terminal of the thin film transistor, a roof layer disposed to face the pixel electrode, and a capping layer disposed on the roof layer, in which a microcavity having a liquid crystal injection hole is formed between the pixel electrode and the roof layer, wherein the microcavity forms a liquid crystal layer including a liquid crystal molecule, and the capping layer covers the liquid crystal injection hole and includes a water-soluble polymer material.

In some embodiments, the water-soluble polymer material may include at least one of polyvinyl alcohol (PVA), methoxypolyethylene glycol, polyethylene glycol, poly(ethylene glycol) diacrylate, polyethylene glycol dimethacrylate, and polyvinylpyrrolidone.

In some embodiments, the capping layer may further include a photoinitiator to have a property allowing a photoprocess.

In some embodiments, the photoinitiator may include at least one of ammonium dichromate, a diazo resin, a styrylpyridium group, and a stilbazolium group.

In some embodiments, the capping layer may further include an adherence accelerator.

In some embodiments, the adherence accelerator may include a material represented by the following Chemical Formula 3:

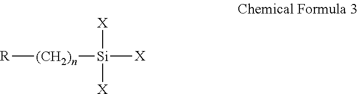

wherein, in Chemical Formula 3, R may include a methyl group, a vinyl group, acrylate group, methacrylate group, —NH₂ or an epoxy group, X may be —OCH₃ or —OCH₂CH₃, and n may be 1 to 30.

In some embodiments, the microcavity may include a plurality of regions corresponding to pixel regions, a liquid crystal injection hole forming region may be formed between the plurality of regions, and the capping layer may cover the liquid crystal injection hole forming region.

In some embodiments, the liquid crystal injection hole forming region may extend in a direction that is parallel to a gate line connected to the thin film transistor.

In some embodiments, the liquid crystal display may further include a common electrode disposed between the microcavity and the roof layer.

In some embodiments, the thin film transistor may be connected to a data line, and a partition forming portion may be formed between the microcavities in an extension direction of the data line.

Some embodiments provide a method of manufacturing a liquid crystal display, including: forming a thin film transistor on a substrate including a display region and a non-display region, forming a pixel electrode on the thin film transistor, forming a sacrificial layer on the pixel electrode, forming a roof layer on the sacrificial layer, forming a microcavity in which a liquid crystal injection hole is formed by removing the sacrificial layer, injecting a liquid crystal material into the microcavity, applying a capping material on the display region and the non-display region so as to cover the roof layer and the liquid crystal injection hole, and forming a capping layer by patterning the capping material to remove the capping material applied on the non-display region.

In some embodiments, the capping material may include a water-soluble polymer material.

In some embodiments, the water-soluble polymer material may include at least one of polyvinyl alcohol (PVA), methoxypolyethylene glycol, polyethylene glycol, poly(ethylene glycol) diacrylate, polyethylene glycol dimethacrylate, and polyvinylpyrrolidone.

In some embodiments, the capping material may further includes a photoinitiator.

In some embodiments, the photoinitiator may include at least one of ammonium dichromate, a diazo resin, a styrylpyridium group, and a stilbazolium group.

In some embodiments, the capping material may have a positive photoresist property.

In some embodiments, the forming of the capping layer may include removing the capping material applied on the non-display region through exposure and developing processes by disposing a mask on the substrate.

In some embodiments, the microcavity may include a plurality of regions corresponding to pixel regions, a liquid crystal injection hole forming region may be formed between the plurality of regions, and the capping layer may be formed to cover the liquid crystal injection hole forming region.

In some embodiments, the liquid crystal injection hole forming region may be formed to extend in a direction that is parallel to a gate line connected to the thin film transistor.

In some embodiments, the method may further include forming a common electrode between the sacrificial layer and the roof layer.

According to the exemplary embodiments of the present disclosure, it is possible to prevent contaminating the liquid crystal by forming a capping layer including a water-soluble polymer material, and to expose a pad portion of an outskirt portion through a photoprocess by forming the capping layer allowing the photoprocess.

### BRIEF DESCRIPTION OF THE DRAWINGS

FIG. 1 is a top plan view illustrating a liquid crystal display according to an exemplary embodiment of the present disclosure.

FIG. 2 is a cross-sectional view taken along cut line II-II of FIG. 1.

FIG. 3 is a cross-sectional view taken along cut line III-III of FIG. 1.

FIG. 4 is a perspective view illustrating a microcavity according to the exemplary embodiment of the present disclosure.

FIG. 5 is a picture obtained by testing the degree of contamination by mixing a capping material according to the exemplary embodiment of the present disclosure with a liquid crystal material.

FIG. 6 is a graph illustrating a test result according to FIG. 5.

FIG. 7 is a flowchart illustrating a method of manufacturing the liquid crystal display according to an exemplary embodiment of the present disclosure.

FIGS. 8 to 11 are top plan views illustrating the method of manufacturing the liquid crystal display according to the exemplary embodiment of the present disclosure.

### DETAILED DESCRIPTION

Hereinafter, exemplary embodiments of the present disclosure will be described in detail with reference to the accompanying drawings. However, the described embodiments may be modified in various different ways, all without departing from the spirit or scope of the present invention. On the contrary, exemplary embodiments introduced herein are provided to make disclosed contents thorough and complete and sufficiently transfer the spirit of the present invention to those skilled in the art.

In the drawings, the thickness of layers, films, panels, regions, etc., are exaggerated for clarity. It will be understood that when a layer is referred to as being “on” another layer or substrate, it can be directly on the other layer or substrate, or intervening them may also be present. Like reference numerals designate like elements throughout the specification.

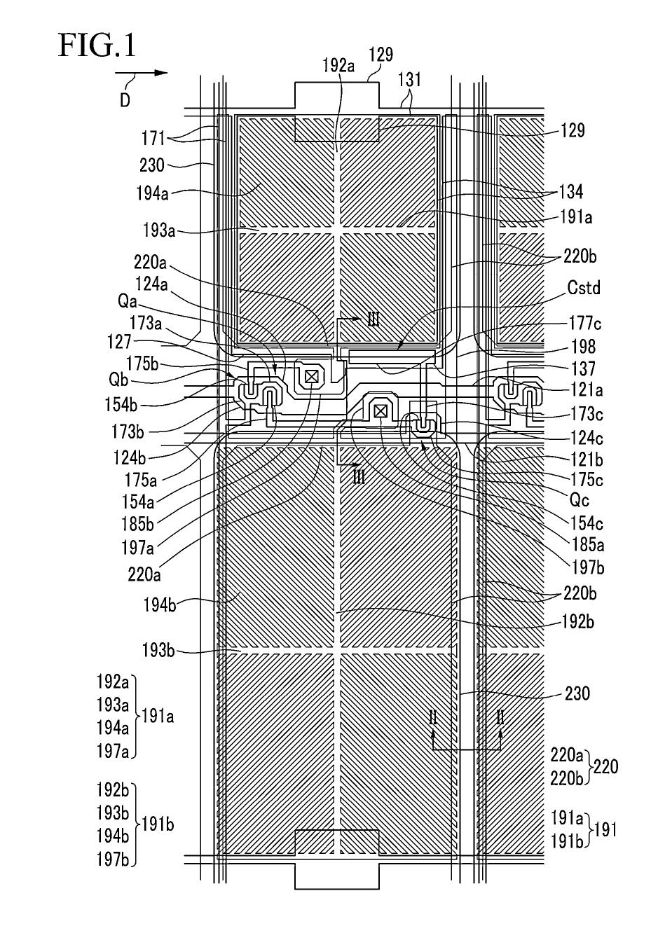

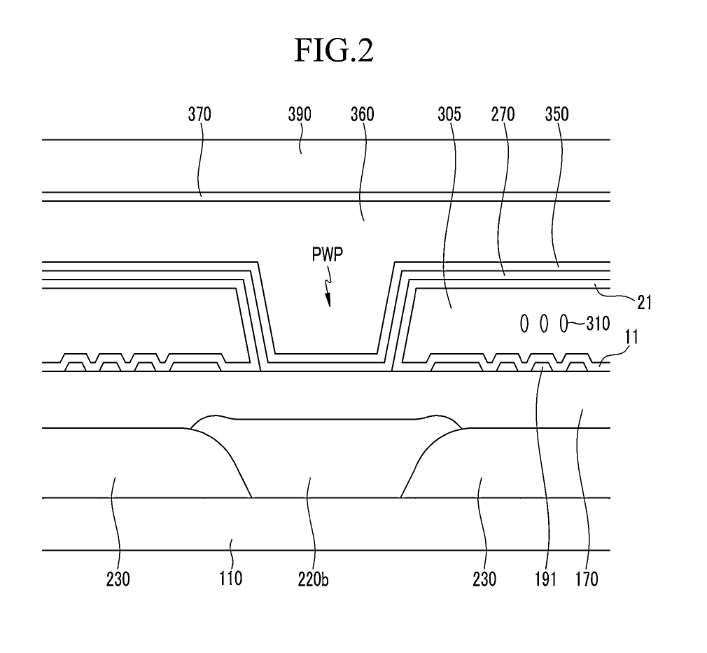

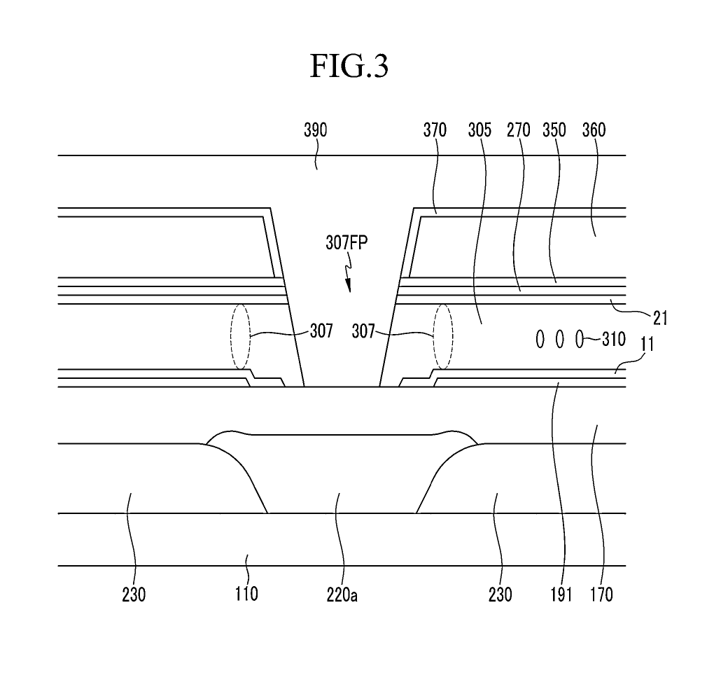

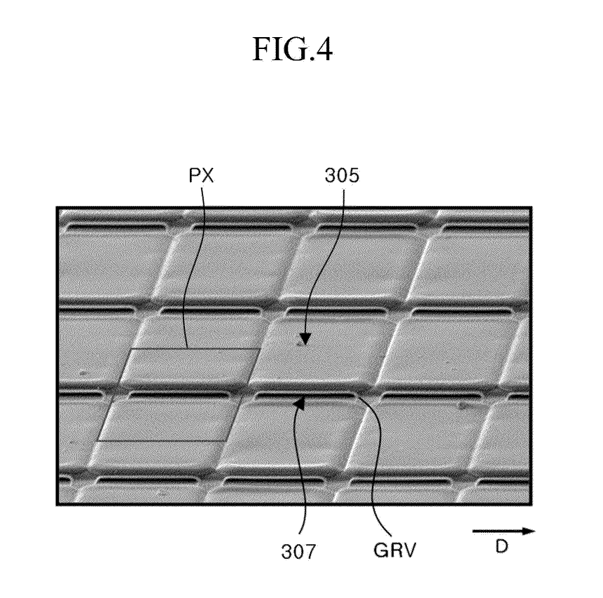

FIG. 1 is a top plan view illustrating a liquid crystal display according to an exemplary embodiment. FIG. 2 is a cross-sectional view taken along cut line II-II of FIG. 1. FIG. 3 is a cross-sectional view taken along cut line III-III of FIG. 1. FIG. 4 is a perspective view illustrating a microcavity according to the exemplary embodiment.

Referring to FIGS. 1 to 3, thin film transistors Qa, Qb, and Qc are disposed on a substrate 110 made of transparent glass or plastic.

In some embodiments, color filter 230 may be disposed on the thin film transistors Qa, Qb, and Qc, and a light blocking member 220 may be formed between the adjacent color filters 230.

FIGS. 2 and 3 are the cross-sectional views taken along cut line II-II and cut line III-III, where a structure between the substrate 110 and the color filter 230 illustrated in FIG. 1 is omitted. In practice, FIGS. 2 and 3 include a portion of the structure of the thin film transistors Qa, Qb, and Qc between the substrate 110 and the color filter 230.

In some embodiments, the color filter 230 may longitudinally extend in a column direction of pixel electrodes 191. In some embodiments, the color filter 230 may display one of primary colors such as three primary colors of red, green, and blue colors. However, the color is not limited to the three primary colors of red, green and blue colors, and one of cyan, magenta, yellow, and white-based colors may be displayed.

In some embodiments, the adjacent color filters 230 may be spaced apart from each other in a horizontal direction D illustrated in FIG. 1 and a vertical direction crossing the horizontal direction. The color filters 230 spaced apart from each other in the horizontal direction D are illustrated in FIG. 2, and the color filters 230 spaced apart from each other in the vertical direction are illustrated in FIG. 3.

Referring to FIG. 2, a vertical light blocking member 220b is disposed between the color filters 230 spaced apart from each other in the horizontal direction D. The vertical light blocking member 220b overlaps with an edge of each of the adjacent color filters 230, and overlapping widths of the vertical light blocking member 220b with both edges of the color filters 230 are substantially the same as each other.

Referring to FIG. 3, a horizontal light blocking member 220a is disposed between the color filters 230 spaced apart from each other in the vertical direction. The horizontal light blocking member 220a overlaps with an edge of each of the adjacent color filters 230, and overlapping widths of the horizontal light blocking member 220a with both edges of the color filters 230 are substantially the same as each other.

Alternatively, the light blocking member 220 may be disposed on a microcavity 305 as will be described later, and in this case, the color filters 230 may be continuously formed in the vertical direction, or the color filters displaying different colors may be formed while overlapping with each other at the edges.

A first passivation layer 170 is disposed on the color filter 230 and the light blocking member 220. In some embodiments, the first passivation layer 170 may be formed of an inorganic material or an organic material, and may serve to planarize layers formed on a lower portion.

In some embodiments, the pixel electrode 191 is disposed on the first passivation layer 170, and is electrically connected through contact holes 185a and 185b to one terminal of the thin film transistors Qa and Qb.

In some embodiments, a lower alignment layer 11 is formed on the pixel electrode 191, and the lower alignment layer 11 may be a vertical alignment layer. In some embodiments, the lower alignment layer 11 may be formed to include at least one of materials generally used as a liquid crystal alignment layer, such as polyamic acid, polysiloxane, or polyimide.

In some embodiments, an upper alignment layer 21 is disposed on a portion facing the lower alignment layer 11, and the microcavity 305 is formed between the lower alignment layer 11 and the upper alignment layer 21. In some embodiments, a liquid crystal material including a liquid crystal molecule 310 is injected into the microcavity 305, and the microcavity 305 has a liquid crystal injection hole 307. In some embodiments, the microcavity 305 may be formed in the column direction of the pixel electrode 191, for example, the vertical direction. In the present exemplary embodiment, the alignment material forming the alignment layers 11 and 21 and the liquid crystal material including the liquid crystal molecule 310 may be injected into the microcavity 305 by using capillary force.

In the present exemplary embodiment, one liquid crystal injection hole is formed at each of both edges of one microcavity 305, but as another exemplary embodiment, only one liquid crystal injection hole may be formed at one edge of one microcavity 305.

In some embodiments, the upper alignment layer 21 is disposed on the microcavity 305, and a common electrode 270 and a lower insulating layer 350 are disposed on the upper alignment layer 21. In some embodiments, the common electrode 270 receives a common voltage and forms an electric field together with the pixel electrode 191 to which a data voltage is applied to determine an inclination direction of the liquid crystal molecule 310 disposed in the microcavity 305 between the two electrodes. In some embodiments, the common electrode 270 and the pixel electrode 191 form a capacitor to maintain the applied voltage even after the thin film transistor is turned off. The lower insulating layer 350 may be formed of silicon nitride (SiNₓ) or silicon oxide (SiO₂).

Formation of the common electrode 270 on the microcavity 305 is described in the present exemplary embodiment, but the common electrode 270 can be formed on a lower portion of the microcavity 305 to drive liquid crystal according to a coplanar electrode (CE) mode as another exemplary embodiment.

In some embodiments, A roof layer 360 is disposed on the lower insulating layer 350. In some embodiments, the roof layer 360 may include silicon oxycarbide (SiOC), a photoresist, or other organic materials. In embodiments where the roof layer 360 includes silicon oxycarbide (SiOC), the roof layer may be formed by a chemical vapor deposition method, and in the case where the roof layer includes the photoresist, the roof layer may be formed by a coating method. Silicon oxycarbide (SiOC) has merits in that transmittance is high and strain does not occur because layer stress is small in the layers formed by the chemical vapor deposition method. Accordingly, in the present exemplary embodiment, if the roof layer 360 is formed of silicon oxycarbide (SiOC), a stable layer through which light passes well may be formed.

In embodiments having a liquid crystal injection hole forming region 307FP passing through the microcavity 305, the common electrode 270, the lower insulating layer 350, and the roof layer 360 is formed on the horizontal light blocking member 220a. In some embodiments, the liquid crystal injection hole forming region 307FP may be covered with a capping layer 390 as will be described later.

In some embodiments, an upper insulating layer 370 may be disposed on the roof layer 360. In some embodiments, the upper insulating layer 370 may come into contact with an upper surface and a lateral wall of the roof layer 360. In some embodiments, the upper insulating layer 370 may be formed of silicon nitride (SiNₓ) or silicon oxide (SiO₂). In some embodiments, the capping layer 390 may be disposed on the upper insulating layer 370. In some embodiments, the capping layer 390 comes into contact with an upper surface and a lateral surface of the upper insulating layer 370, and the capping layer 390 covers the liquid crystal injection hole 307 of the microcavity 305 exposed by the liquid crystal injection hole forming region 307FP.

In some embodiments, the capping layer 390 may be formed at a portion corresponding to a display region.

The capping layer 390 according to the present exemplary embodiment includes a water-soluble polymer material. In the present exemplary embodiment, the water-soluble polymer material may be polyvinyl alcohol represented by the following Chemical Formula 1:

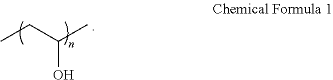

Further, the water-soluble polymer material according to the present exemplary embodiment may include at least one of methoxypolyethylene glycol, polyethylene glycol, poly(ethylene glycol) diacrylate, polyethylene glycol dimethacrylate, and polyvinylpyrrolidone.

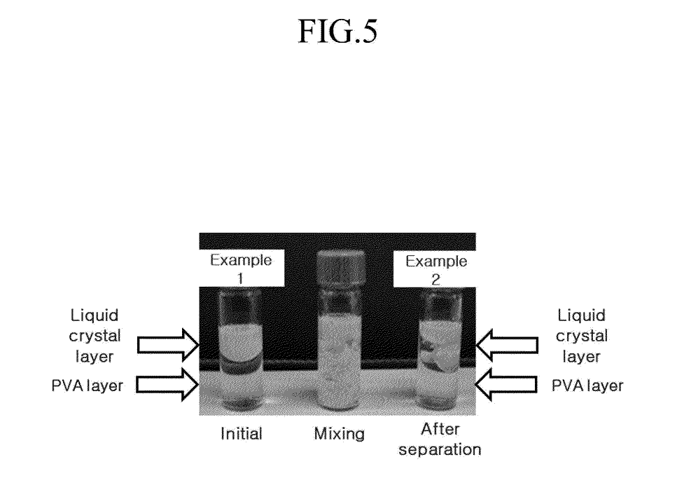

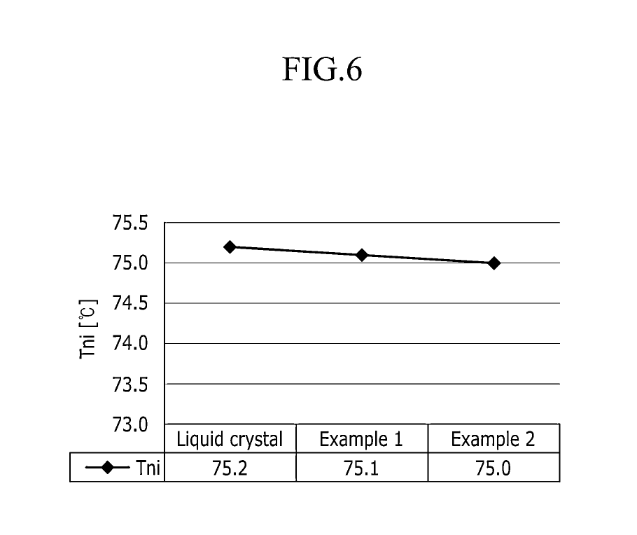

In the present exemplary embodiment, since the capping layer 390 includes the water-soluble polymer material, even though the capping layer comes into contact with the liquid crystal material that is hydrophobic, the liquid crystal material is not contaminated. A detailed description thereof will be described later with reference to FIGS. 5 and 6. Further, the capping layer 390 may further include an adherence accelerator. Herein, the adherence accelerator may be a compound represented by the following Chemical Formula 3:

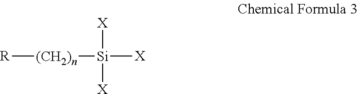

wherein, in Chemical Formula 3, R may include a methyl group, a vinyl group, acrylate group, methacrylate group, —NH₂ or an epoxy group, each X may be —OCH₃ or —OCH₂CH₃, and n may be 1 to 30. For example, the adherence accelerator may be (3-aminopropyl)triethoxysilane or 3-(trimethoxysilyl)propyl methacrylate.

In some embodiments, an overcoat layer (not illustrated) formed of an inorganic layer or an organic layer may be disposed on the capping layer 390. In some embodiments, the overcoat layer serves to protect the liquid crystal molecule 310 injected into the microcavity 305 from an external impact and planarize the layer.

Hereinafter, the microcavity 305 will be specifically described with reference to FIGS. 1 to 4.

Referring to FIGS. 1 to 4, the microcavity 305 is divided in a vertical direction by a plurality of liquid crystal injection hole forming regions 307FP disposed at an overlapping portion with a gate line 121a, and is formed in plural in an extension direction D of the gate line 121a. The microcavities 305 formed in plural each correspond to the pixel regions, and groups of the microcavities 305 formed in plural are formed in plural in a column direction. Herein, the pixel region may correspond to a region displaying an image.

The present exemplary embodiment has thin film transistor and pixel electrode structures where two sub-pixel electrodes 191a and 191b are disposed with the gate line 121a interposed therebetween. Accordingly, the first sub-pixel electrode 191a and the second sub-pixel electrode 191b of each of the pixels PX adjacent to each other in a vertical direction may correspond to one microcavity 305. However, since this structure can modify the thin film transistor and pixel electrode structures, modification into a form where the microcavity 305 corresponds to one pixel PX is feasible.

In this case, the liquid crystal injection hole forming region 307FP formed between the microcavities 305 may be disposed in an extension direction D of the gate line 121a, and the liquid crystal injection hole 307 of the microcavity 305 forms a region corresponding to a boundary portion between the liquid crystal injection hole forming region 307FP and the microcavity 305. In some embodiments, the liquid crystal injection hole 307 is formed in the extension direction of the liquid crystal injection hole forming region 307FP. In addition, a partition forming portion PWP formed between the microcavities 305 adjacent to each other in the extension direction D of the gate line 121a, as illustrated in FIG. 3, may be covered with the roof layer 360. In the present exemplary embodiment, the lower insulating layer 350, the common electrode 270, the upper insulating layer 370, and the roof layer 360 are filled in the partition forming portion PWP, and this structure may form a partition to section or define the microcavity 305.

In the present exemplary embodiment, it is described in that the liquid crystal injection hole forming region 307FP is formed in the extension direction D of the gate line 121a, but as another exemplary embodiment, the liquid crystal injection hole forming region 307FP may be formed in plural in the extension direction of a data line 171, and groups of the microcavities 305 formed in plural may be formed in plural in a row direction. In some embodiments, the liquid crystal injection hole 307 may be formed in the extension direction of the liquid crystal injection hole forming region 307FP formed in the extension direction of the data line 171.

In the present exemplary embodiment, since the liquid crystal material is injected through the liquid crystal injection hole 307 of the microcavity 305, the liquid crystal display may be formed without forming a separate upper substrate.

Hereinafter, the liquid crystal display according to the present exemplary embodiment will be described in detail with reference to FIGS. 1 to 4 again.

Referring to FIGS. 1 to 4, a plurality of gate conductors including a plurality of gate lines 121a, a plurality of voltage drop gate lines 121b, and a plurality of storage electrode lines 131 are formed on the substrate 110 made of transparent glass or plastic.

In some embodiments, the gate line 121a and the voltage drop gate line 121b mainly extend in a horizontal direction and transfer a gate signal. In some embodiments, the gate line 121a includes a first gate electrode 124a and a second gate electrode 124b that protrude upwardly and downwardly, and the voltage drop gate line 121b includes a third gate electrode 124c that protrudes upwardly. In some embodiments, the first gate electrode 124a and the second gate electrode 124b are connected to each other to form one protrusion.

In some embodiments, the storage electrode line 131 mainly extends in a horizontal direction and transfers a predetermined voltage such as a common voltage Vcom. In some embodiments, the storage electrode line 131 includes a storage electrode 129 that protrudes upwardly and downwardly, a pair of vertical portions 134 that substantially vertically extend downwardly in respect to the gate line 121a, and a horizontal portion 127 through which ends of the pair of vertical portions 134 are connected to each other. In some embodiments, the horizontal portion 127 includes a capacitive electrode 137 extending downwardly.

In some embodiments, a gate insulating layer (not illustrated) is formed on the gate conductors 121a, 121b, and 131.

In some embodiments, a plurality of semiconductor stripes (not illustrated) that may be made of amorphous, crystalline silicon, or the like are formed on the gate insulating layer. In some embodiments, the semiconductor stripe mainly extends in a vertical direction, and includes first and second semiconductors 154a and 154b extending toward the first and second gate electrodes 124a and 124b and connected to each other, and a third semiconductor 154c disposed on the third gate electrode 124c.

In some embodiments, a plurality pairs of ohmic contacts (not illustrated) may be formed on the semiconductors 154a, 154b, and 154c. In some embodiments, the ohmic contacts may be made of silicide or a material such as n+ hydrogenated amorphous silicon to which an n-type impurity is doped at a high concentration.

In some embodiments, a data conductor including a plurality of data lines 171, a plurality of first drain electrodes 175a, a plurality of second drain electrodes 175b, and a plurality of third drain electrodes 175c is formed on the ohmic contacts.

In some embodiments, the data line 171 transfers a data signal and mainly extends in a vertical direction to cross the gate line 121a and the voltage drop gate line 121b. Each data line 171 includes a first source electrode 173a and a second source electrode 173b extending toward the first gate electrode 124a and the second gate electrode 124b and connected to each other.

In some embodiments, the first drain electrode 175a, the second drain electrode 175b, and the third drain electrode 175c each include one wide end portion and the other rod-shaped end portion. In some embodiments, the rod-shaped end portions of the first drain electrode 175a and the second drain electrode 175b are partially surrounded by the first source electrode 173a and the second source electrode 173b. In some embodiments, the one wide end portion of the first drain electrode 175a further extends to form a U-shaped bent third drain electrode 175c. In some embodiments, the wide end portion 177c of the third source electrode 173c overlaps with the capacitive electrode 137 to form a voltage drop capacitor Cstd and the rod-shaped end portion may be partially surrounded by the third drain electrode 175c.

In some embodiments, the first gate electrode 124a, the first source electrode 173a, and the first drain electrode 175a form a first thin film transistor Qa together with the first semiconductor 154a, the second gate electrode 124b, the second source electrode 173b, and the second drain electrode 175b form a second thin film transistor Qb together with the second semiconductor 154b, and the third gate electrode 124c, the third source electrode 173c, and the third drain electrode 175c form a third thin film transistor Qc together with the third semiconductor 154c.

In some embodiments, the semiconductor stripe including the first semiconductor 154a, the second semiconductor 154b, and the third semiconductor 154c may have a plane shape that is substantially the same as those of the data conductor 171, 173a, 173b, 173c, 175a, 175b, and 175c and the ohmic contacts therebeneath with the exception of channel regions between the source electrodes 173a, 173b, and 173c and the drain electrodes 175a, 175b, and 175c.

In some embodiments, an exposed portion that is not covered by the first source electrode 173a and the first drain electrode 175a is present between the first source electrode 173a and the first drain electrode 175a in the first semiconductor 154a, an exposed portion that is not covered by the second source electrode 173b and the second drain electrode 175b is present between the second source electrode 173b and the second drain electrode 175b in the second semiconductor 154b, and an exposed portion that is not covered by the third source electrode 173c and the third drain electrode 175c is present between the third source electrode 173c and the third drain electrode 175c in the third semiconductor 154c.

In some embodiments, an insulating layer (not illustrated) that may be made of an inorganic insulator such as silicon nitride or silicon oxide is formed on the data conductor 171, 173a, 173b, 173c, 175a, 175b, and 175c and the exposed portions of the semiconductors 154a, 154b, and 154c.

In some embodiments, the color filter 230 may be disposed on the insulating layer. In some embodiments, the color filter 230 may be disposed in most regions other than regions in which the first thin film transistor Qa, the second thin film transistor Qb, the third thin film transistor Qc, and the like are disposed. In some embodiments, the color filter 230 may longitudinally extend in a vertical direction along the space between the data lines 171 that are adjacent to each other. In the present exemplary embodiment, the color filter 230 is formed at a lower end of the pixel electrode 191, but may be formed on the common electrode 270.

In some embodiments, a light blocking member 220 may be disposed on the region in which the color filter 230 is not disposed and a portion of the color filter 230. In some embodiments, the light blocking member 220 extends along the gate line 121a and the voltage drop gate line 121b to expand upwardly and downwardly, and includes a horizontal light blocking member 220a covering the region in which the first thin film transistor Qa, the second thin film transistor Qb, the third thin film transistor Qc, and the like are disposed, and a vertical light blocking member 220b extending along the data line 171.

In some embodiments, the light blocking member 220 is called a black matrix and prevents light leakage.

In some embodiments, a plurality of contact holes 185a and 185b through which the first drain electrode 175a and the second drain electrode 175b are exposed are formed in the insulating layer and the light blocking member 220.

In addition, a first passivation layer 170 may be formed on the color filter 230 and the light blocking member 220. In some embodiments, the pixel electrode 191 including the first sub-pixel electrode 191a and the second sub-pixel electrode 191b is formed on the first passivation layer 170. In some embodiments, the first sub-pixel electrode 191a and the second sub-pixel electrode 191b are separated from each other with the gate line 121a and the voltage drop gate line 121b interposed therebetween and are disposed thereon and therebeneath to be adjacent to each other in a column direction. In some embodiments, the second sub-pixel electrode 191b may be approximately 1 to 3 times larger than the first sub-pixel electrode 191a.

In some embodiments, the whole shape of each of the first sub-pixel electrode 191a and the second sub-pixel electrode 191b is a quadrangle, and the first sub-pixel electrode 191a and the second sub-pixel electrode 191b each include a cross-type stem portion formed of horizontal stem portions 193a and 193b and vertical stem portions 192a and 192b crossing the horizontal stem portions 193a and 193b. Further, the first sub-pixel electrode 191a and the second sub-pixel electrode 191b each include a plurality of fine branch portions 194a and 194b, and protrusions 197a and 197b that protrude downwardly or upwardly from edge sides of the sub-pixel electrodes 191a and 191b.

In some embodiments, the pixel electrode 191 is divided into four sub-regions by the horizontal stem portions 193a and 193b and the vertical stem portions 192a and 192b. In some embodiments, the fine branch portions 194a and 194b obliquely extend from the horizontal stem portions 193a and 193b and the vertical stem portions 192a and 192b, and the extension direction thereof may form an angle of approximately 45° or 135° with the gate lines 121a and 121b or the horizontal stem portions 193a and 193b. Further, the extension directions of the fine branch portions 194a and 194b of the two adjacent sub-regions may be orthogonal to each other.

In the present exemplary embodiment, the first sub-pixel electrode 191a further includes an outskirt stem portion surrounding an outskirt thereof, and the second sub-pixel electrode 191b further includes horizontal portions disposed at an upper end and a lower end, and left and right vertical portions 198 disposed at the left and the right of the first sub-pixel electrode 191a. In some embodiments, the left and right vertical portions 198 may prevent capacitive bonding, that is, coupling, between the data line 171 and the first sub-pixel electrode 191a.

In some embodiments, the lower alignment layer 11, a microcavity layer 400, the upper alignment layer 21, the common electrode 270, the lower insulating layer 350, the capping layer 390, and the like are formed on the pixel electrode 191, and the constituent elements is described above, and thus omitted.

A description of the liquid crystal display described until now is an example of a visibility structure for improving lateral surface visibility, a structure of the thin film transistor and a pixel electrode design are not limited to the structure described in the present exemplary embodiment, but the content according to a modification of the exemplary embodiment of the present invention may be applied.

FIG. 5 is a picture obtained by testing the degree of contamination by mixing the capping material forming the capping layer according to the exemplary embodiment of the present disclosure with the liquid crystal material.

Referring to FIG. 5, polyvinyl alcohol represented by the following Chemical Formula 2:

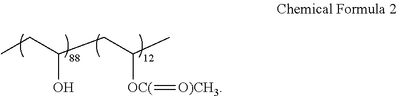

The polyvinyl alcohol was initially put into one glass test tube with the liquid crystal material. Herein, polyvinyl alcohol may be in an uncured state. The liquid crystal material may be any liquid crystal material known by one of skill in the art include.

The initial glass test tube corresponds to Example 1 in a state where the liquid crystal material and polyvinyl alcohol (PVA) are combined without mixing and then stored for 3 days at room temperature. An intermediate glass test tube represents a mixing state obtained by shaking the glass test tube in Example 1. After separation, the glass test tube corresponds to Example 2 in a state where the liquid crystal layer and polyvinyl alcohol are mixed and then stored at room temperature for 3 days in the intermediate glass test tube.

When viewed by the naked eye, in Example 1, the liquid crystal layer and the polyvinyl alcohol layer are vertically separated and there is no mixing phenomenon. In the intermediate glass test tube, when the liquid crystal layer and the polyvinyl alcohol layer were mixed, two materials seemed to be temporarily mixed. However, like in Example 2, when the intermediate glass test tube was stored at room temperature for 3 days, the liquid crystal layer and the polyvinyl alcohol layer were vertically separated from each other like an initial state.

From the aforementioned result, it could be confirmed that in the present exemplary embodiment, even though the capping layer including the water-soluble polymer material temporarily came into contact with the liquid crystal by mixing, the capping layer and the liquid crystal did not maintain contact and separated.

FIG. 6 is a graph illustrating a test result according to FIG. 5.

An initial transition temperature (nematic isotropic temperature; Tni) of the liquid crystal material is 75.2° C. In comparison, the transition temperature is 75.1° C. in Example 1, and the transition temperature is 75.0° C. in Example 2. Thus, a transition temperature change is 0.1° C. in Example 1, and a transition temperature change is 0.2° C. in Example 2. As described above, the transition temperature change is a method capable of indirectly confirming the degree of contamination of liquid crystal. Even though the liquid crystal material and polyvinyl alcohol are mixed like in Example 1, it can be confirmed that contamination is hardly present. Further, similar to Example 2, even though the liquid crystal material and polyvinyl alcohol are mixed by forcibly shaking the glass test tube, the liquid crystal material and polyvinyl alcohol seem to be temporarily mixed, but it can be confirmed that the liquid crystal material and polyvinyl alcohol are finally separated and a transition temperature change is 0.2° C., which is not large.

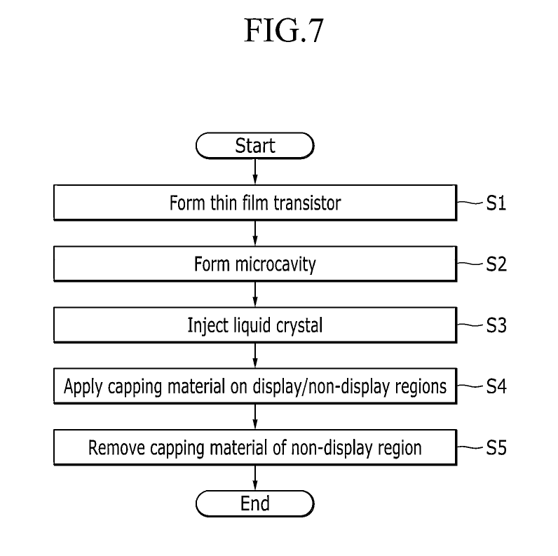

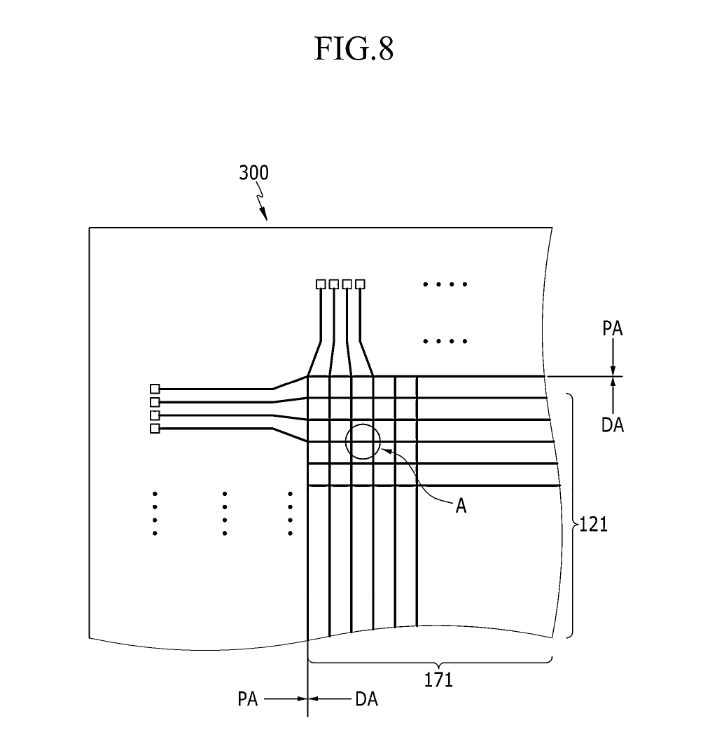

FIG. 7 is a flowchart illustrating a method of manufacturing the liquid crystal display according to an exemplary embodiment of the present disclosure. FIGS. 8 to 11 are top plan views illustrating the method of manufacturing the liquid crystal display according to the exemplary embodiment of the present invention.

Referring to FIG. 7, the method of manufacturing the liquid crystal display according to the exemplary embodiment of the present invention includes forming the thin film transistor on the substrate (S1).

The thin film transistor may act as a switching element in the present exemplary embodiment, and may control, input, and output a signal in order to display an image.

In the present exemplary embodiment, as illustrated in FIG. 1, the three thin film transistors Qa, Qb, and Qc are formed such that the signal is controlled, inputted, and outputted, but this thin film transistor structure can be modified.

Referring back to FIGS. 1 to 3, the organic layer 230 is formed to correspond to the pixel region on the thin film transistors Qa, Qb, and Qc, and the light blocking members 220a and 220b are formed between the adjacent organic layers 230.

Thereafter, the pixel electrode 191 including a fine branch portion is formed on the organic layer 230. In some embodiments, the pixel electrode 191 may be made of a transparent conductor such as ITO or IZO.

In some embodiments, a sacrificial layer is formed of a material including a photoresist and the like on the pixel electrode 191, and the partition forming portion PWP is formed on the vertical light blocking member 220b by exposing/developing or patterning the sacrificial layer. In some embodiments, the partition forming portion PWP may section the microcavities 305 adjacent to each other in a horizontal direction.

Thereafter, the method includes forming the microcavity (S2).

The method of forming the microcavity 305 will be described with reference back to FIGS. 1 to 3. In some embodiments, the common electrode 270 and the lower insulating layer 350 are sequentially formed on the sacrificial layer. In some embodiments, the common electrode 270 may be formed of a transparent conductor such as ITO or IZO, and the lower insulating layer 350 may be formed of silicon nitride (SiNₓ) or silicon oxide (SiO₂). In some embodiments, the roof layer 360 and the upper insulating layer 370 are sequentially formed on the lower insulating layer 350. The roof layer 360 according to the present exemplary embodiment may be formed of a material that is different from the aforementioned sacrificial layer. In some embodiments, the upper insulating layer 370 may be formed of silicon nitride (SiNₓ) or silicon oxide (SiO₂).

In some embodiments, the liquid crystal injection hole forming region 307FP through which the lower insulating layer 350 of a portion corresponding to the horizontal light blocking member 220a is exposed may be formed by patterning the roof layer 360 before the upper insulating layer 370 is formed. Thereafter, the sacrificial layer is exposed by sequentially patterning the upper insulating layer 370, the lower insulating layer 350, and the common electrode 270 disposed at a portion corresponding to the liquid crystal injection hole forming region 307FP, and the sacrificial layer is removed through the liquid crystal injection hole forming region 307FP by oxygen (O₂) ashing treatment, a wet etching method, or the like. In this case, the microcavity 305 having the liquid crystal injection hole 307 is formed. In some embodiments, the microcavity 305 is in a hollow space state because the sacrificial layer is removed.

In some embodiments, the alignment layers 11 and 21 are formed on the pixel electrode 191 and the common electrode 270 by injecting an alignment material through the liquid crystal injection hole 307.

Next, the liquid crystal material including the liquid crystal 310 may be injected through the liquid crystal injection hole 307 into the microcavity 305 by using an inkjet method or the like (S3).

Referring to FIG. 8, the liquid crystal display according to the exemplary embodiment of the present disclosure includes a liquid crystal panel assembly 300, a gate driver (not illustrated) and a data driver (not illustrated) connected thereto, a gray voltage generator (not illustrated) connected to the data driver, a light source portion (not illustrated) irradiating light on the liquid crystal panel assembly 300, a light source driver (not illustrated) controlling the light source portion, and a signal controller (not illustrated) controlling them.

In some embodiments, the gate driver or the data driver may be formed on the liquid crystal panel assembly 300, or may be formed as a separate integrated circuit chip.

The substrate 110 (illustrated in FIGS. 2 and 3) of the liquid crystal panel assembly 300 includes a display region DA and a non-display region PA. In some embodiments, the display region DA is a region where an actual image is outputted, and in the non-display region PA, the aforementioned gate driver or data driver is formed, or a pad portion including a gate pad 121p, a data pad 171p, or the like, which is a portion connected to an external circuit, is disposed. In some embodiments, the gate pad 121p is a wide portion disposed at an end of the gate line 121, and the data pad 171p is a wide portion disposed at an end of the data line 171.

A portion of the aforementioned liquid crystal display according to FIGS. 1 to 4 may indicate portion A in FIG. 8.

Next, if the liquid crystal material is injected, since the liquid crystal material may be exposed to the outside by the liquid crystal injection hole A, the method includes applying the capping material so as to cover the liquid crystal injection hole A (S4).

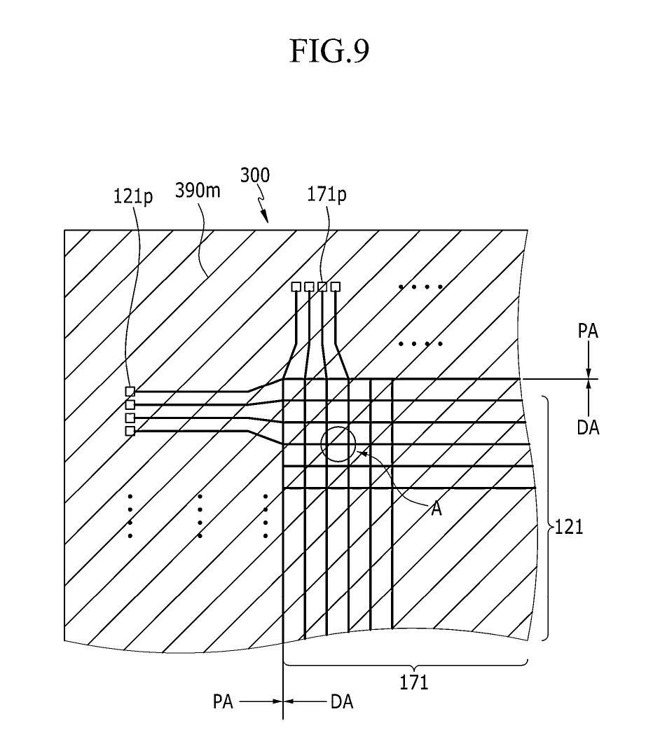

In this case, referring to FIG. 9, a capping material 390m according to the present exemplary embodiment is applied on the non-display region PA as well as the display region DA. Since the capping material 390m is applied on the non-display region PA, the gate pad 121p and the data pad 171p are covered during this step of the method.

Next, the method includes removing the capping material of the non-display region PA (S5).

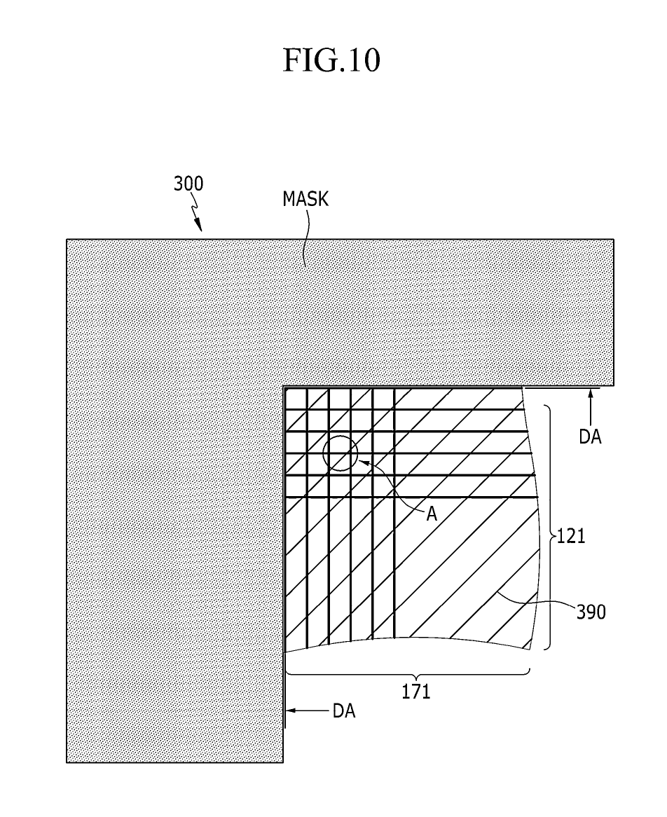

Referring to FIG. 10, an exposure process is performed while a portion corresponding to the non-display region PA is covered with a mask MASK so as to cover the pad portion including the gate pad 121p and the data pad 171p.

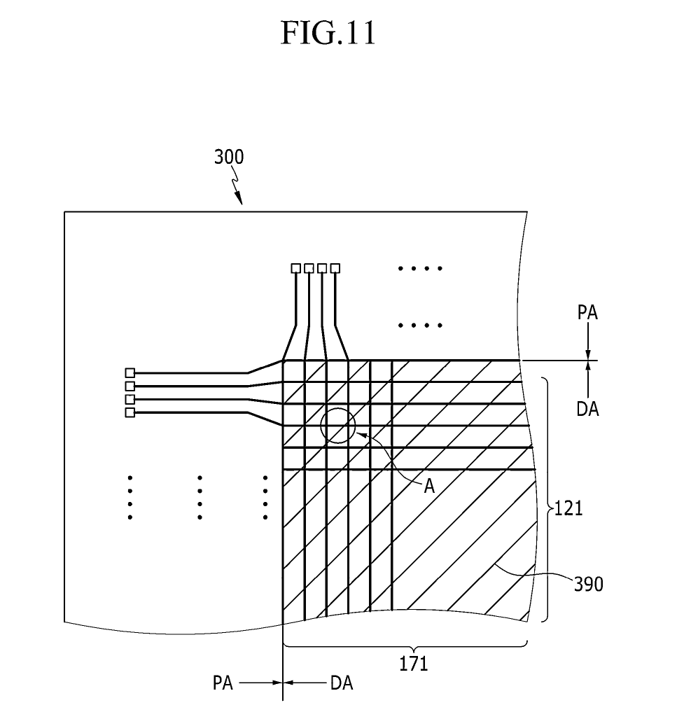

Referring to FIG. 11, the liquid crystal displays of FIGS. 2 and 3 are formed by removing the mask MASK and removing a capping material 390p covering the non-display region PA through a developing process to form the capping layer 390. Like this, since the capping material according to the exemplary embodiment of the present disclosure includes a photoinitiator to have a photoresist property, patterning is feasible through a photoprocess.

In the present exemplary embodiment, patterning is performed in a negative photoresist form in which a portion not receiving light is removed during exposure. Alternatively, the capping material may be formed of a material having a positive photoresist property, and in this case, patterning may be performed by using a mask that is a reverse image of the aforementioned mask MASK. Performing patterning after the capping material having the positive photoresist property is applied is preferable in view of the fact that a deterioration in a characteristic of the liquid crystal display by radiation of unnecessary light on the display region DA can be minimized.

While the embodiments have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a substrate;
a thin film transistor disposed on the substrate;
a pixel electrode connected to one terminal of the thin film transistor;
a roof layer disposed to face the pixel electrode; and
a capping layer disposed on the roof layer,
wherein a microcavity having a liquid crystal injection hole is disposed between the pixel electrode and the roof layer, the microcavity comprises a liquid crystal layer comprising a liquid crystal molecule, and
the capping layer covers the liquid crystal injection hole and comprises a water-soluble polymer material.

2. The liquid crystal display of claim 1, wherein:
the water-soluble polymer material comprises at least one of polyvinyl alcohol (PVA), methoxypolyethylene glycol, polyethylene glycol, poly(ethylene glycol) diacrylate, polyethylene glycol dimethacrylate, and polyvinylpyrrolidone.

3. The liquid crystal display of claim 1, wherein:
the microcavity comprises a plurality of regions corresponding to pixel regions, a liquid crystal injection hole forming region is disposed between the plurality of regions, and the capping layer covers the liquid crystal injection hole forming region.

4. The liquid crystal display of claim 3, wherein:
the liquid crystal injection hole forming region extends in a direction that is parallel to a gate line connected to the thin film transistor.

5. The liquid crystal display of claim 1, further comprising:
a common electrode disposed between the microcavity and the roof layer.

6. The liquid crystal display of claim 1, wherein:
the thin film transistor is connected to a data line, and a partition forming portion is disposed between the microcavities in an extension direction of the data line.

7. A method of manufacturing a liquid crystal display, comprising:
forming a thin film transistor on a substrate including a display region and a non-display region,
forming a pixel electrode on the thin film transistor,
forming a sacrificial layer on the pixel electrode,
forming a roof layer on the sacrificial layer,
forming a microcavity in which a liquid crystal injection hole is formed by removing the sacrificial layer,
injecting a liquid crystal material into the microcavity,
applying a capping material on the display region and the non-display region so as to cover the roof layer and the liquid crystal injection hole, and
forming a capping layer by patterning the capping material to remove the capping material applied on the non-display region.

8. The method of manufacturing a liquid crystal display of claim 7, wherein:
the capping material comprises a water-soluble polymer material.

9. The method of manufacturing a liquid crystal display of claim 8, wherein:
the water-soluble polymer material comprises at least one of polyvinyl alcohol (PVA), methoxypolyethylene glycol, polyethylene glycol, poly(ethylene glycol) diacrylate, polyethylene glycol dimethacrylate, and polyvinylpyrrolidone.

10. The method of manufacturing a liquid crystal display of claim 9, wherein:
the capping material further comprises a photoinitiator.

11. The method of manufacturing a liquid crystal display of claim 10, wherein:
the photoinitiator comprises at least one of ammonium dichromate, a diazo resin, a styrylpyridium group, and a stilbazolium group.

12. The method of manufacturing a liquid crystal display of claim 11, wherein:
the capping material has a positive photoresist property.

13. The method of manufacturing a liquid crystal display of claim 7, wherein:
the forming of the capping layer comprises
removing the capping material applied on the non-display region through exposure and developing processes by disposing a mask on the substrate.

14. The method of manufacturing a liquid crystal display of claim 7, wherein:
the microcavity comprises a plurality of regions corresponding to pixel regions, a liquid crystal injection hole forming region is formed between the plurality of regions, and the capping layer is formed to cover the liquid crystal injection hole forming region.

15. The method of manufacturing a liquid crystal display of claim 14, wherein:
the liquid crystal injection hole forming region is formed to extend in a direction that is parallel to a gate line connected to the thin film transistor.

16. The method of manufacturing a liquid crystal display of claim 7, further comprising:
forming a common electrode between the sacrificial layer and the roof layer.

17. The method of manufacturing a liquid crystal display of claim 7, wherein:
the capping layer further comprises a photoinitiator to have a property allowing a photoprocess.

18. The method of manufacturing a liquid crystal display of claim 17, wherein:
the photoinitiator comprises at least one of ammonium dichromate, a diazo resin, a styrylpyridium group, and a stilbazolium group.

19. The method of manufacturing a liquid crystal display of claim 7, wherein:
the capping layer further comprises an adherence accelerator.

20. The method of manufacturing a liquid crystal display of claim 19, wherein:
the adherence accelerator comprises a compound represented by the following Chemical Formula 3: 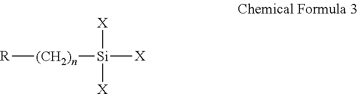
wherein, in Chemical Formula 3, R comprises a methyl group, a vinyl group, acrylate group, methacrylate group, NH₂ or an epoxy group, X is —OCH₃ or —OCH₂CH₃, and n is 1 to 30.
